(19) United States
(12) Patent Application Publication
(10) Pub. No.: US 2023/0136168 A1
(43) Pub. Date: May 4, 2023

(54) BLOWER ASSEMBLY WITH DETACHABLE MOTOR MODULE

(71) Applicants: Miguel CASTELLOTE, Frampton (CA); Dominique CIECHANOWSKI, Frampton (CA)

(72) Inventors: Miguel CASTELLOTE, Frampton (CA); Dominique CIECHANOWSKI, Frampton (CA)

(21) Appl. No.: 18/050,222

(22) Filed: Oct. 27, 2022

Related U.S. Application Data
(60) Provisional application No. 63/272,867, filed on Oct. 28, 2021.

(51) Int. Cl. F04D 25/06; F04D 29/40

(52) U.S. Cl. CPC F04D 25/06; F04D 29/403

(57) ABSTRACT

A blower assembly for a tub, a hand dryer, etc, may include a first module securable to a structure, the first module defining one of an air inlet and an air outlet. A second module defining the other of the air inlet and the air outlet, the second module including a motor, the motor drivingly engaged to a blower to, in use, drive an air flow from the air inlet to the air outlet. The second module is detachably securable to the first module such that the second module is secured to the structure via the first module.

### CROSS-REFERENCE TO RELATED APPLICATION

The present application claims the priority of U.S. Patent Application No. 63/272,867, filed on Oct. 28, 2021.

### TECHNICAL FIELD

This disclosure generally relates to the field of air blowers used in tubs, hand dryers, and so on.

### BACKGROUND

Tubs are well known for their primary use, namely a washroom installation in which a user person washes and bathes. Tubs have, however, evolved to add pleasure and comfort to practicality, and are found in many forms, such as bathtubs, spas and whirlpools.

Massage systems of various configurations have been provided to inject fluids, such as air or water, into the liquid of the tub, so as to procure a massaging effect for the occupant of the tub. Different types of air massage systems for tubs exist on the market, and some may include blower assemblies to inject the air. These blower assemblies have an electrical motor driving a fan or blower for driving an air flow therethrough. These electrical motors have limited life span and replacing them is often cumbersome. Hence, improvements are sought.

### SUMMARY

In one aspect, there is provided a blower assembly, comprising: a first module securable to a structure, the first module defining one of an air inlet and an air outlet; and a second module defining the other of the air inlet and the air outlet, the second module including a motor, the motor drivingly engaged to a blower to, in use, drive an air flow from the air inlet to the air outlet, wherein the second module is detachably securable to the first module such that the second module is secured to the structure via the first module.

In another aspect, there is provided a blower assembly comprising: a first module securable to a structure, the first module defining one of an air inlet and an air outlet, the first module configured to be wired to a power source, and having a first electrical connector; and a second module defining the other of the air inlet and the air outlet, the second module including a motor, the motor drivingly engaged to a fan to, in use, drive an air flow from the air inlet to the air outlet, wherein the second module is wireless and has a second electrical connector; wherein the second module is detachably securable to the first module by a translation such that the second module is secured to the structure via the first module, and such that the first connector and the second connector are electrically connected for the second module to be electrically powered via the first module.

### BRIEF DESCRIPTION OF THE DRAWINGS

Reference is now made to the accompanying figures in which:

FIG. 1 is a schematic cutaway view of a bath tub in accordance with one embodiment;

FIG. 2 is a schematic view of an air distribution system in accordance with one embodiment that may be used with the bath tub of FIG. 1;

FIG. 3 is a plan view of a blower assembly of the air distribution system of FIG. 2 shown in an assembled configuration;

FIG. 4 is a three dimensional view of the blower assembly of FIG. 3 shown in a disassembled configuration;

FIG. 5 is a three dimensional exploded view of a heating module of the blower assembly of FIG. 3;

FIG. 6 is a cross-sectional exploded view of the heating module of FIG. 5;

FIG. 7 is a three dimensional exploded view of a motor module of the blower assembly of FIG. 3;

FIG. 8 is a cross-sectional exploded view of the motor module of FIG. 7;

FIG. 9 is an enlarged three dimensional view of a portion of the motor module of FIG. 7;

FIG. 10A is a three dimensional view of a portion of the blower assembly of FIG. 3 shown in a disassembled configuration;

FIG. 10B is a three dimensional view of the portion of the blower assembly of FIG. 3 shown in a partially assembled configuration; and

FIG. 10C is a three dimensional view of the portion of the blower assembly of FIG. 3 shown in an assembled configuration.

### DETAILED DESCRIPTION

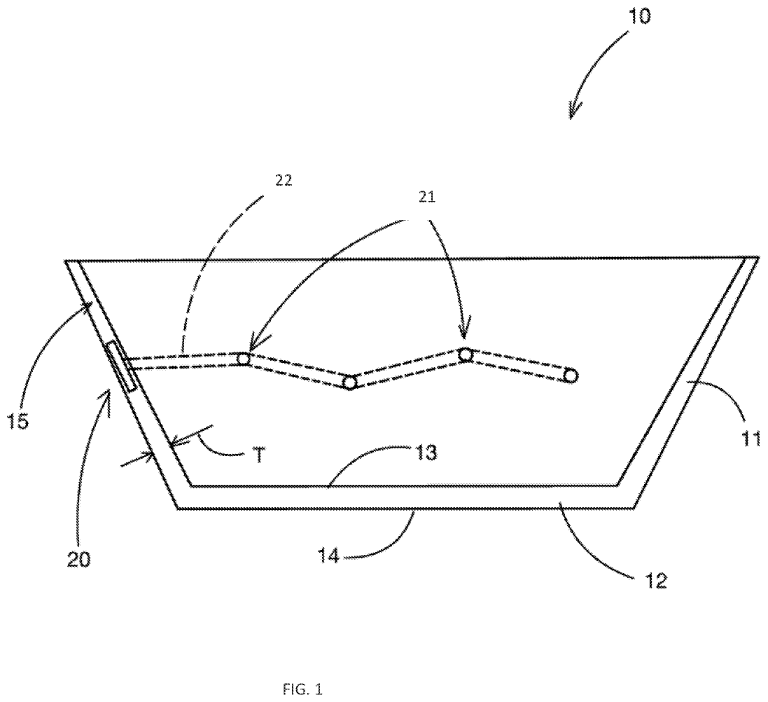

Referring to FIG. 1, a bathtub, referred to below simply as “tub” is shown at 10. The expression tub is used herein to describe any such bathing cavity, and may also be referred to as bath, whirlpool, etc. The tub 10 is configured to contain water or like liquids and includes sides 11 and a bottom 12. The sides 11 may be an assembly of a plurality of interconnected walls distributed around the bottom wall 12 or a single wall having curved portions and extending annularly all around the bottom wall 12. While the expression “interconnected walls” is used, the tub 10 may have a monolithic continuous surface, seamless, with the interconnection resulting from a manufacturing process. The sides 11 protrude generally upwardly from the bottom wall 12 to define an inner volume for receiving and containing water. The sides and bottom 11, 12 of the tub 10 have inner walls 13 and outer walls 14. A space 15 may be defined between the inner and outer walls 13, 14, for instance if the tub 10 is a freestanding tub. The inner walls 13 are being wetted by water when the tub 10 contains water. If the tub 10 is a freestanding tub, both the inner walls 13 and the outer walls 14 may be visually exposed. In an embodiment, the tub 10 has at least part of the outer walls 14 concealed, as the tub 10 may be embedded in a supporting structure. In such a scenario, there may also only be a single wall 13 (i.e., no outer wall 14). As another embodiment, the tub 10 may be said to have only one wall have inner surface 13 and outer surface 14 (that may be concealed), with a space 15 (a.k.a., empty volume, cavity, plenum) optionally between the surfaces 13 and 14 of the single wall.

In the illustrated embodiment, the tub 10 is a self-supporting tub, commonly referred to as a freestanding tub. Such a tub has the required stiffness to be able to hold the water in the tub 10 and may be solely supported on a ground. In other words, a freestanding tub may not rely on beams (e.g. 2×4) of a wall adjacent the tub for support. As shown, the bottom wall 12 may be laid against the ground. In some cases, legs may be appended to the tub to create an interface between the tub 10 and the ground. The thinning of the side walls is customer driven who want a more esthetic tub, but the price point of such freestanding tubs often require the use of materials other than metal. The thinner side walls of modern freestanding tub make it difficult to incorporate air distribution systems and to replace components of such system when required. However, the air distribution system 20 described herein may be used with any other type of tub 10.

The tub 10, or any other type of tub, may be equipped with an air distribution system 20 for generating bubbles, air flow or water movement, by injecting air in the water of the tub 10. The air distribution system 20 includes jets 21 for outputting a stream of air to create massaging jets or other effects for a user of the tub 10. In an embodiment, the jets 21 are holes in the walls of the tub 10, with the holes being in fluid communication with the air distribution system 20. In another embodiment, the jets 21 have tubular bodies mounted to holes in the tub walls.

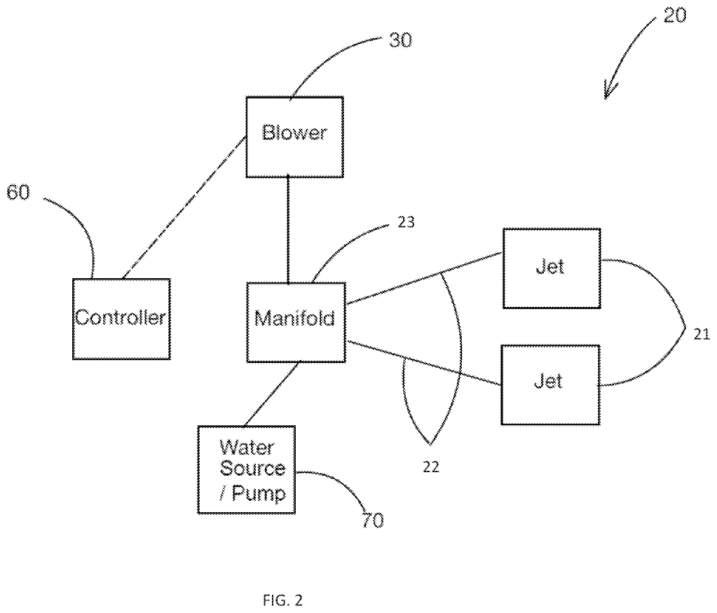

Referring now to FIG. 2, the different components of the air distribution system 20 are shown schematically. In the embodiment shown, the air distribution system 20 may include a blower assembly 30 that is operable to draw ambient air and push this drawn ambient air via one or more suitable conduits directly to jets 21, or to a manifold 23. Alternatives to a blower assembly 30 include a fan, a ventilator, a pump, etc. The manifold 23 is optionally present to be pneumatically connected to the blower assembly 30 and pneumatically connected to jets 21 via conduits 22, only two being shown here for illustration purposes, for creating the massaging streams in the water of the tub 10. If present, the manifold 23 may be optionally connected to a water source or pump 70 to mix water with air to be injected in the tub via the jets 21. In the present disclosure, the expression “conduit” is intended to encompass any structure suitable for flowing a fluid, such as air and water. A conduit may be, for instance, a pipe, a hose, a tubular member, tubing, a channel, a passage, a plenum and so on.

The air distribution system 20 may include a controller 60 that is operatively connected to the blower assembly 30 for operating the air distribution system 20, with functions such as on/off, and optionally for controlling an amount of air injected in the tub 10 via the jets 21. The controller 60 may be operatively connected to the air massage system for selectively controlling which of a second set of jets (not shown) is injecting air in the tub 10. Such an air massage system and controller is described in U.S. Pat. No. 7,503,082, the entire contents of which are incorporated herein by reference.

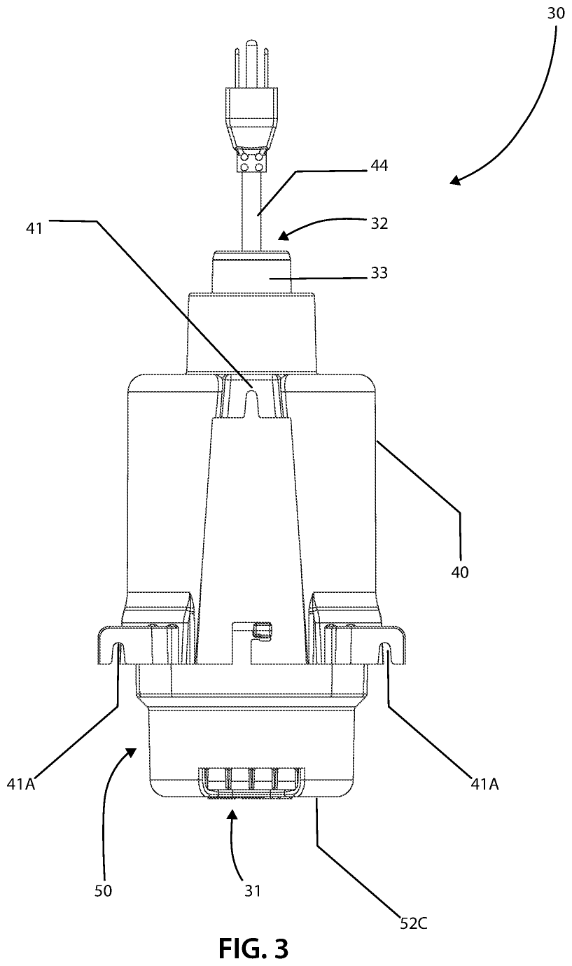

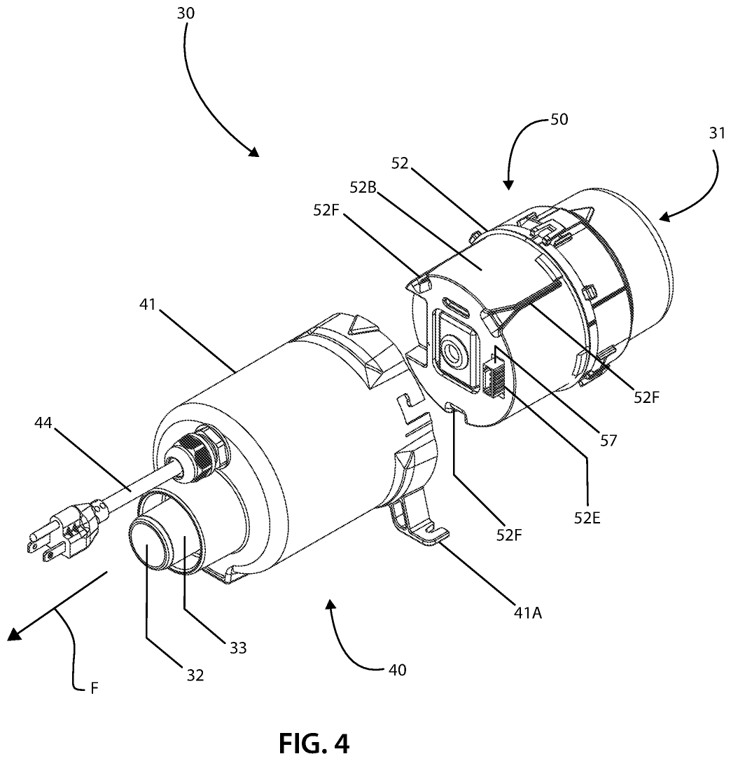

Referring now to FIGS. 3-4, the blower assembly 30 is shown in greater detail. The blower assembly 30 defines an air inlet 31 at a first end of the blower assembly 30 and an air outlet 32 at a second end of the blower assembly 30, that may for example be axially opposed to the air inlet 31. As observed in FIG. 3, the air inlet 31 may be in a lateral portion of the blower assembly 30 (as opposed to being at an axial end). Thus, at installation, the air inlet 31 may be oriented in a selected manner, such as toward the ground for example. As a result, the noise level exhibited by the blower assembly 30 may be reduced in comparison to other positions of the air inlet 31 (such as on an axial end face of the blower assembly 30). The blower assembly 30 is operable to draw air flow F from the air inlet 31 to the air outlet 32. The air outlet 32 may define a connector 33 via which a hose or other suitable conduit may be connected. The blower assembly 30 includes an electrical motor to drive a fan, a blower, an impeller, or other fluid machine to drive an air flow through the blower assembly 30.

Electrical motors, such as brushed motors, are prone to failure. Typically, they may last from about 300 to 500 hours. Once the motor breaks or reaches its end of life by the brushes being worn out, it is often required to replace an entirety of a legacy blower, which may be complicated since the blower has to be disconnected both electrically from a power source and pneumatically from the conduits 22. This may be quite challenging because the blower assembly 30 is often located in a small space not easily accessible. The blower assembly 30 of the present disclosure may at least partially alleviate these drawbacks.

The blower assembly 30 includes a heating module 40 and a motor module 50. The motor module 50 is detachably securable to the heating module 40 as will be explained in further detail below. The heating module 40 may be secured to the tub 10, for instance to a wall of the tub 10. The heating module 40 is described first with reference numerals in the 40s. The motor module 50 is then described with reference numeral in the 50s. It will be appreciated that, in an alternate embodiment, some parts of the motor module 50 may be located in the heating module 40 and vice versa without departing from the scope of the present disclosure.

As will be explained below, the motor module 50 houses a motor of the blower assembly 30. The motor may be the part having the shortest lifespan in the blower assembly 30. Typically, when the motor breaks or needs replacement, the whole blower assembly 30 needs replacing, which may be time consuming and costly. The disclosed blower assembly 30, by way of the motor module 50 containing the motor, may be more rapidly repaired than when a replacement is required, by simply substituting another motor module, containing another motor, for the broken one. Time savings may therefore be achieved.

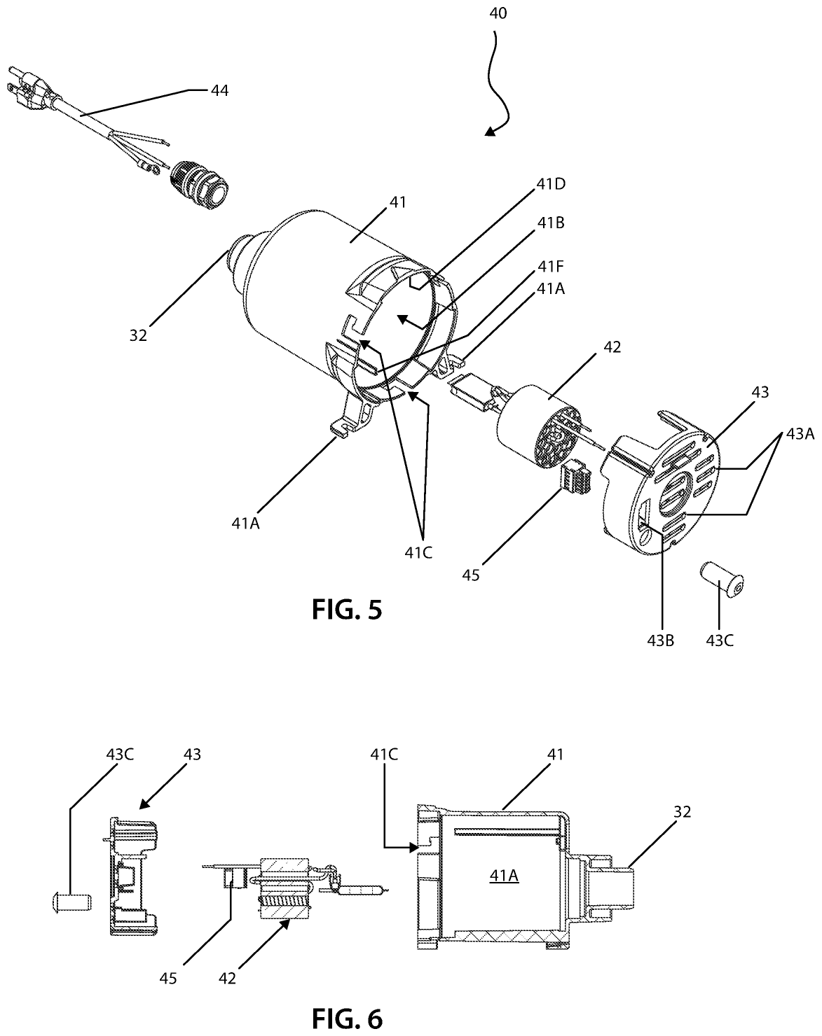

Referring now to FIGS. 5-6, the heating module 40 includes a housing 41, which acts as a conduit to direct the air flow F from the air inlet 31 to the air outlet 32 of the blower assembly 30. The housing 41 may optionally define legs 41A, two in the embodiment shown but more or less is contemplated, that are used to secure the heating module 40 to the tub 10, to a structure surrounding the tub 10, or to the ground or floor. The legs 41A may project from a cylindrical body of the housing 41, the cylindrical body of the housing 41 being one possible shape among others. Other types of supports or connections may be used to secure the housing 41 to the bath or surrounding structure. The heating module 40 may be mounted to the wall of the tub 10, to a structure, to the ground or floor in any suitable ways. For instance, brackets may be used for that purpose, or fasteners cooperating with the legs 41A or instead of the legs 41A. The housing 41 defines the air outlet 32 of the blower assembly 30. The heating module 40 includes an optional heating element 42 that is operable to warm up the air flow F flowing through the blower assembly 30. The heating element 42 is received within an inner cavity 41B defined by the housing 41. The heating element 42 (or heating elements 42) may be resistive coils or like elements that convert electric current to heat. A cover plate 43 may be provided and may be removably securable to the housing 41 for enclosing the heating element 42 in the housing 41, acting optionally as a heat shield for electronic components associated with the motor module 50. The cover plate 43 defines apertures 43A to allow the air flow F to flow through the cover plate 43. The heating element 42 may be secured to the housing 41 either directly or via the cover plate 43. The cover plate 43 further defines a connector aperture 43B for defining a passage for a connector as will be described below. All safety components may be present to avoid safety hazards associated with the use of electricity and heat, such safety components not named here. A biasing member(s) 43C (one or more) may be mounted to the cover plate 43, such as to have a biasing end project from a plate of the cover plate 43, and into the cavity receiving the motor module 50. The biasing member 43C is sized and positioned for the biasing end to come into contact with the motor module 50 that is assembled to the heating module 40, as described below. Accordingly, the biasing member 43C may exert a pressing action on the motor module 50, for reasons explained below. The biasing member 43C may be a coil spring, a leaf spring, a resilient elastic pad, among other possibilities. The biasing member 43C, if present, may be at other locations in the heating module 40, or on the motor module 50.

A power cable 44 (a.k.a., cable, power cable) is secured to the housing 41. Hence, in the embodiment shown, electrical power is provided to some of the components of the blower assembly 30 via the heating module 40. It may alternatively be provided by the motor module 50. The power cable 44 is therefore electrically connected to the heating element 42. The heating module 40 further includes a first connector 45, which may be mounted within the housing 41 aligned with the connector aperture 43B such that the first connector 45 is accessible when the cover plate 43 is disposed over the opening of the housing 41. The first connector 45 is electrically connected to the power cable 44. The first connector 45 is used to transmit power from the heating module 40 to the motor module 50 of the blower assembly 30 as will be explained further below. The heating module 40 for instance includes coils that convert electrical power to heat, for instance by the coils being resistive or including a coolant heated by resistive elements, among other possibilities.

Still referring to FIGS. 5-6, the housing 41 defines one or more, three in the embodiment shown, first connecting members, which correspond herein to L-shaped slots 41C that are circumferentially interspaced around a periphery of the housing 41. The L-shaped slots 41C are located adjacent an opening of the inner cavity 41B. The L-shaped slots 41C extend from a peripheral edge 41D of the housing 41 that circumscribes the opening of the inner cavity 41B. These L-shapes slots 41C are used to removably secure the motor module 50 to the heating module 40 as will be explained below. It will be appreciated that other shapes for the slots are contemplated without departing from the scope of the present disclosure, such as a J shape, an inverted L, a T. When assembled, the cover plate 43 may be inside of the housing 41, with the portion of the housing 41 including the first connecting members 41C (such as the L-shaped slots) projecting beyond a main plane of the cover plate 43, whereby the first connecting members 41C are exposed for connection with complementary components. The cover plate 43 may be entered well inside the housing 41 to define a cavity for receiving the motor module 50 therein.

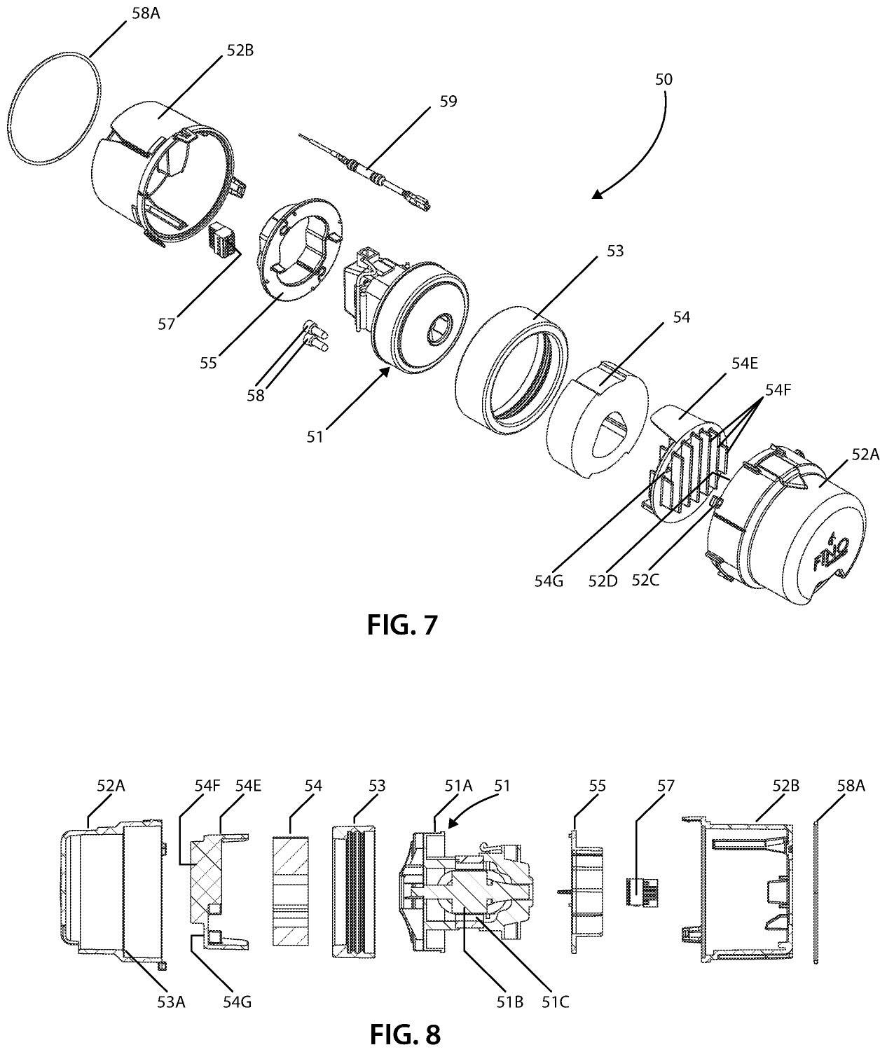

Referring now to FIGS. 7-8, the motor module 50 is described in more detail. The motor module 50 encloses an electrical motor assembly, referred to below as motor assembly 51. The motor assembly 51 includes an electric motor 51B drivingly engaged to a fan 51C (such as Fino™ blower), blower, impeller, or any other suitable device able to drawn an air flow. The electric motor 51B drives rotation of the fan 51C to induce the air flow F from the air inlet 31 to the air outlet 32.

The motor assembly 51 is received within a housing assembly 52 that may include a rear housing 52A and a front housing 52B removably securable to the rear housing 52A. The front and rear housings 52A, 52B conjointly define an inner cavity for receiving the motor assembly 51. The expressions “front” and “rear” may not have any meaning as to the orientation of the blower 30, but may merely be present to distinguish between the housings 52A and 52B. Moreover, housings 52A and 52B may also be referred to as housing portions, concurrently forming a single housing for the motor assembly 51. The front and rear housings 52A, 52B are an option among others, with a housing and cover plate being another. Once the heating module 40 is secured to the motor module 50, at least a portion of the front housing 52B may be received within the housing 41 of the heating module 40, e.g., between the plane of the cover plate 43 and the peripheral edge 41D. However, this need not be the case and other configurations are contemplated.

As shown more particularly in FIG. 8, the motor assembly 51 is mounted to the housing assembly 52 via a damper 53. The damper 53 has a ring shape, but other shapes are contemplated. The damper 53 is disposed around the motor assembly 51 until the damper 53 abuts a first shoulder 51A defined by the motor assembly 51. The damper 53 may be used to limit transmission of vibrations from the motor assembly 51 to the housing 52 and to the tub 10, structure or ground. In some configurations, the damper 53 may be omitted.

The motor module 50 may further include acoustic material 54, having a ring or sleeve shape in the embodiment shown, that is slidably received within the rear housing 52A. The acoustic material 54 may be interfaced to the rear housing 52A via support 54E. The support 54E may have legs that fit in complementary peripheral slots in the acoustic material to block any rotational movement between the acoustic material 54 and the support 54E. Moreover, fins 54F may be on an end plate portion of the support 54E, and contribute to the cooling of the motor module 50. The fins 54F are in the flow path of incoming air entering via the inlet 31A, with the support 54E having an air passage 54G. Thus, the relatively cool inlet air may contribute to the absorption of heat. Then, the motor assembly 51 and the damper 53 are slidably received in the rear housing 52A until the damper 53 abuts a second shoulder 53A (FIG. 8) defined at an intersection between two sections of different diameters of the rear housing 52A. Other stopper arrangements may be used, such as circlips, etc, to assist in locating the damper 53, if present. The acoustic material 54 may include acoustic foam. In some embodiments, the acoustic material 54 and/or the support 54E is(are) omitted. A cover 55 may be abutted against the motor assembly 51 and may be engaged to the rear housing 52A to lock the motor assembly 51, the damper 53, and the foam material 54 inside the rear housing 52A. The cover 55 has a ring shape, but other shapes are contemplated. The cover 55 may have a support neck portion 55A shaped to receive an end of the motor assembly 51. The shapes of the many components may be altered as long as the air is able to flow through the blower assembly 30.

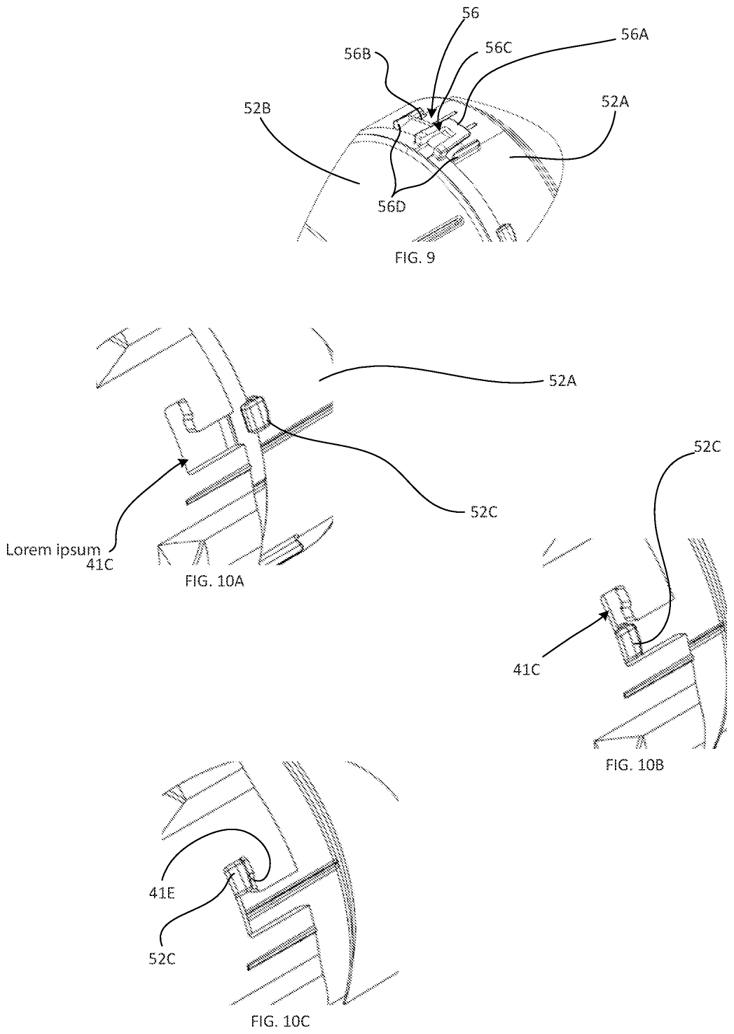

Referring more particularly to FIG. 9, the rear housing 52A is removably securable to the front housing 52B via one or more snap clips, three snap clips 56 being in the embodiment shown. The snap clips 56 may include U-shaped tabs 56A connected to the front housing 52B. The U-shaped tabs 56A are engageable by abutments such as ribs 56B on the rear housing 52A. The ribs 56B may extend in a circumferential direction along a portion of a circumference of the rear housing 52A. The U-shaped tabs 56A may alternatively be defined by the rear housing 52A and the ribs 56B by the front housing 52A. Other interconnection components may also be used as alternatives. In use, the rear and front housings 52A, 52B are rotated one relative to the other until the U-shaped tabs 56A are in register with the ribs 56B. Then, the rear and front housings 52A, 52B are moved toward one another until the U-shaped tabs 56A come into contact with the ribs 56B. Further force to bring closer the rear and front housings 52A, 52B results in the U-shaped tabs 56A bending away (e.g., by elastic deformation) from the rear housing 52A until the tabs 56A are past the ribs 56B and catch a surface thereof, as observed via recesses or apertures 56C enclosed by the U-shaped tabs 56A, thereby limiting movements of the rear and front housings 52A, 52B one relative to the other. The ribs 56B may therefore be wedge formations, or latches. The pairs of complementary tabs 56A and ribs 56B may be described as being complementary snap-fit connectors, or quick connectors. In the embodiment shown, the rear and front housings 52A, 52B are rotatable one relative to the other by a sliding motion of the ribs 56B in relationship to the U-shaped tabs 56A. Stoppers 56D, which may be provided in the form of longitudinal lips, may be provided at both extremities of each of the ribs 56B. The stoppers 56D are abuttable against the U-shaped tabs 56A to limit an amplitude of movements of the rear housing 52A relative to the front housing 52B. It will be appreciated that any other means for locking the rear and front housings 52A, 52B together are contemplated. For instance, the rear and front housings 52A, 52B may be fused, welded, glued, fastened together or any combination of the above without departing from the scope of the present disclosure. Any other locking means, such as bayonet lock, latches, keyway and so on may alternatively be used. Consequently, when the housings 52A and 52B are interconnected, a rotational degree of freedom is present between them (i.e., a rotational joint), but of limited and controlled amplitude. If more than one present, the complementary pairs of tabs 56A and ribs 56B (or equivalent complementary connectors) may not be equidistantly spaced on the circumferences of the rear and front housings 52A, 52B, to define some clocking feature if a desired orientation is required between the rear housing 52A and the front housing 52B. This is optional.

Referring back to FIGS. 7-8, the rear housing 52A defines one or more, three in the embodiment shown, second connecting members, which are herein tabs 52C that are circumferentially distributed around a peripheral edge 52D of the rear housing 52A. The tabs 52C are slidably receivable within the L-shaped slots 41C (FIG. 5) defined by the housing 41 of the heating module 40. As will be described below with reference to FIGS. 10A-10C, the cooperation of the tabs 52C and the L-shaped slots 41C make the motor module 50 detachable from the heating module 40. The tabs 52C may be surface features that are integrally part of the rear housing 52A (for instance a molded feature) or front housing 52B, The tabs 52C may be projections on an otherwise continuous outer surface of the housing 52A or 52B.

The motor module 50 further includes a second connector 57 (FIG. 7) that is electrically connectable to the first connector 45 (FIG. 5) in a plug and socket manner for example, when the motor module 50 is secured to the heating module 40. Accordingly, the second connector 57 is accessible from an end wall of the rear housing 52A of the motor module 50, for instance via an opening 52E extending therethrough as shown in FIG. 4. The second connector 57 is electrically connected to the motor assembly 51. In the embodiment shown, electrical power provided from the power cable 44 is provided to the motor module 50 via the heating module 40 (which may include a PCB to support such component). Hence, when it is time to replace the motor assembly 51, a user may simply separate the motor module 50 from the heating module 40 without having to unplug or otherwise disconnect the motor assembly 51 from any power source. Simplicity, safety, and time savings may be achieved by such a configuration. In other embodiments, the motor module 50 may be connected directly to a power source.

In the embodiment shown, the motor module 50 includes secondary connectors 58 and a fuse 59. The fuse 59 is electrically connected to the motor of the motor assembly 51 and is operable to disconnecting the motor from the power source should power drawn by the electric motor exceeds a given threshold. This may occur, for instance, if rotation of the electric motor is impeded. The fuse 59 is therefore a safety feature, among numerous others that may be present.

Referring now to FIG. 10A, in the depicted embodiment, to assemble the motor module 50 to the heating module 40, the two modules 40, 50 are oriented in relationship to one another until the tabs 52C are in register with openings of the L-shaped slots 41C. To assist, slots 41C may not be equidistantly circumferentially distributed (with tabs 52C having a similar pattern) to ensure that a precise alignment is achieved to connect the two modules 40, 50, as a form of clocking feature or clocking distribution. Thus, as shown in FIG. 10B, the tabs 52C are inserted in longitudinal portions of the L-shaped slots 41C until they become aligned with transversal portions of the L-shaped slots. At this point, the first and second connectors 45, 57 become electrically connected to one another via the first and second connectors 45, 57, that were previously aligned in orientation. As shown in FIG. 100, the two modules 40, 50 are rotated one relative to the other until the tabs 52C are locked inside the transversal portions of the L-shaped slots 41C (which may feature an end tooth to form a catch). At that point, the heating module 40 and the motor module 50 are engaged and electrically connected to one another. Protrusions 41E may be defined by the housing 41 and may face the transversal portions of the L-shaped slots 41C. The protrusions 41E may act as a stopper to limit rotation of the two modules 40, 50 relative to each other.

In the embodiment shown, a rotation of the first and second connectors 45, 57 relative to the rear housing 52A has to be allowed to permit the rotation of the tabs 52C, which are defined by the rear housing 52A, within the transversal portions of the L-shaped slots 41C and to maintain the first and second connectors 45, 57 electrically coupled to one another. In the present embodiment, this is permitted by the relative motion of the rear and front housings 52A, 52B of the motor module 50 and, more specifically, by the rotational DOF of limited amplitude, e.g., the sliding of the U-shaped tabs 56A in relationship to the ribs 56B as bound by the stoppers 56D. Hence, once the first and second connectors 45, 57 become electrically connected to one another, the front housing 52B remains immobile relative to the housing 41 of the heating module 40. Rotation of the rear housing 52A of the motor module 50 relative to the front housing 52B, thanks to the sliding motion of the U-shaped tabs 56A relative to the ribs 56B or like rotational DOF, allows the insertion of the tabs 52C into the transversal portions of the U-shaped slots 41C while maintaining the first and second connectors 45, 57 electrically coupled. Stated differently, a rotational joint is provided between the portion of the motor module 50 having the connectors 52C (the tabs) and the portion of the motor module 50 having the electrical connector 57.

In some embodiments, the electrical connection between the first and second connectors 45, 57 may be achieved solely after the rotation of the two modules 40, 50 and when the tabs 52C are received within the transversal portion of the L-shaped slots 41C, for example by having complementary connectors 45, 57 having radial faces (as opposed to the axial faces shown in the figures). The connection between the heating module 40 and the motor module 50 may be substantially air tight to minimize air leaks. Seals, such as O-ring 58A, may be provided for that purpose. In some cases, the contact between the two housings 41, 52A may be sufficient in limiting the leaks. Seal 58A may bring a biasing effect to contribute to the locking of the modules 40 and 50.

The afore-described locking means of the two modules 40, 50 may be referred to as a bayonet lock. It will be appreciate that any other suitable means for removably locking the two modules 40, 50 together are contemplated without departing from the scope of the present disclosure. For instance, snap clips as described above with reference to FIGS. 7-8 may be used. Any other suitable means may be used. For instance, the two modules 40, 50 may be threaded to one another. This may be achieved by having mating threads defined by both of the housing 41 of the heating module 40 and the rear housing 52A of the motor module 50. In some other embodiments, a keyway engagement, tongue and grooves, snap fit, and so on may be used to removably secure the two modules together. In some cases, latches may be used to lock the two modules together. In other words, the first and second connecting members may include any means matingly engageable to one another that may suitably detachably lock the two modules 40, 50 to one another.

Consequently, in an embodiment, when the module 50 is connected to the module 40 that is on site, the module 50 is aligned in rotation with the module 40, and then forwarded into engagement into the module 40, by a translation. The translation is stopped when the modules 40 and 50 abut with electrical connection made between them. To lock the modules 40 and 50, a rotation of the rear housing 52A is made relative to the front housing 52B and the module 40, as the module 40 and the front housing 52B are immovable relative to one another (and electrically connected). Biasing pressure may be exerted by the biasing member 43C (if present) to ensure that the modules 40 and 50 remain locked (e.g., if a tooth is present as described above). The rotation of the rear housing 52A allows same to engage to the module 40, with an example being shown in FIGS. 10A to 10C. The rotational degree of freedom is optional, as it may be possible to use fasteners as an option to secure the modules 40 and 50 to one another to preserve the electrical connection between them.

The principles of the present disclosure are not limited to tub blowers and may be used in many applications. For instance, hand dryer of public restrooms may benefit from this technology since electrical motors of such hand dryer are prone to failure. Hence, a technician may easily repair the hand dryer by simply substituting a new motor module 50, containing a new motor, for the broken one. Time savings may therefore be achieved.

Since the heating module 40 is the one electrically connected to the power source and pneumatically connected to a remainder of the air distribution system 20 (FIG. 1), or to a nozzle of a hand dryer, and remains attached to the tub 10, or to a casing of the hand dryer, it may not be required to electrically and pneumatically disconnected the blower assembly 30 prior to replacing the motor assembly 51. The simple movements of the motor module 50 relative to the heating module 40 as explained above with reference to FIGS. 10A-10C electrically disconnects the motor assembly 51 from the power source thanks to the first and second connectors 45, 57 contained within the respective housings 41, 52. The simple movements would entail a rotation to dislodge the bayonet lock, and a pulling action to separate the connectors 45, 57 and remove the motor module 50 from the heating module 40 (e.g., with the assistance of a spring, such as in the biasing member 43C), with the heating module 40 remaining secured. A replacement motor module 50 could then be used, or the removed motor module 50 could be repaired.

A foolproof or alignment feature may be defined by one or both of the two modules 40, 50 to prevent a user from angularly misaligning the two modules 40, 50 when engaging them to each other. This foolproof feature may include a keyway engagement between the front housing 52B of the motor module 50 and the housing 41 of the heating module 40. In the embodiment shown, the keyway engagement includes one or more grooves 52F (FIG. 4) defined on an outer face of the front housing 52B and one or more keys 41F (only one shown in FIG. 5) defined on an inner face of the housing 41 of the heating module 40 (reversal of these features is possible). In the embodiment shown, three grooves 52F and three keys 41F are used. The grooves and the keys 52F, 41F are distributed non-equidistantly around a circumference of the housings 41, 52B. The one or more grooves and keys 52F, 41F may ensure that the housings 41, 52B are engageable to one another in a single orientation one relative to the other. Moreover, as a result, a translation joint may be formed between the front housing 52B and the housing 41, to force engagement of the electrical connectors 45, 57. This may ensure a proper alignment of the two connectors 45, 57 when engaging the motor module 50 to the heating module 40. The foolproof feature may include any other means to ensure proper alignment of the two modules. These means may include, for instance, visual indicators, non-circular shape of the housings, etc.

While it is referred to as heating module 40, the module 40 may not have a heating element as explained above. The module 40 may be in a variant referred to as the electrical module, as in such variant it is the module 40 that is connected to a power source (e.g., grid, battery), while the motor module 50 is not. Moreover, the module 40 may also be regarded as the outlet module in another variant. While the air outlet could be on either module 40 or 50, in the illustrated variant it is the module 40 that is connected to the air outlet, e.g., via the pipe coupling shown, such that the pipe or like conduit can remain connected to the blower assembly 30 when the module 50 is separated therefrom for maintenance. The air inlet 31 may be in the module 50 as the air inlet 31 may draw air from ambient, i.e., it may not be connected to a conduit. The blower may be in either module 40 or 50.

A flow channel of the blower assembly 30, i.e., from the air inlet 31 to the air outlet 32, may include flow of air through the air passage 54G (and through fins 54F), into the motor assembly 51 and fan 51C to be propelled, among other components that may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A blower assembly, comprising:
a first module securable to a structure, the first module defining one of an air inlet and an air outlet; and
a second module defining the other of the air inlet and the air outlet, the second module including a motor, the motor drivingly engaged to a blower to, in use, drive an air flow from the air inlet to the air outlet,
wherein the second module is detachably securable to the first module such that the second module is secured to the structure via the first module.

2. The blower assembly of claim 1, wherein the blower is mounted to either one of the first module and the second module.

3. The blower assembly of claim 1, including a heating element in the first module and in a flow channel between the air inlet and air outlet to heat air passing therethrough.

4. The blower assembly of claim 1, wherein the first module has a power inlet for connection to an electrical power source, the motor electrically connected to the electrical power source through the first module.

5. The blower assembly of claim 1, wherein the air outlet is defined by the first module and the air inlet defined by the second module.

6. The blower assembly of claim 1, wherein the first module includes a first electrical connector and the second module includes a second electrical connector, the first connector electrically connected to the second connector when the first module is engaged to the second module.

7. The blower assembly according to claim 6, wherein the first module and the second module form a translation joint therebetween for engagement of the first electrical connector with the second electrical connector when the second module penetrates the first module.

8. The blower assembly according to claim 7, wherein the second module has a rotational joint between a first housing and a second housing thereof, the second electrical connector being in the first housing, the rotational joint allowing the second housing to be rotated into locking engagement with the first module while the first electrical connector and the second electrical connector remain electrically connected.

9. The blower assembly according to claim 8, wherein the first housing the second housing are releasably connected by snapfit connectors.

10. The blower assembly of claim 1, wherein the first module defines at least one first connecting member matingly engageable to at least one second connecting member defined by the second module to maintain the first module secured to the second module.

11. The blower assembly of claim 10, wherein the at least one first connecting member includes one of an L-shaped slot and a tab and wherein the at least one second connecting member includes the other of the L-shaped slot and the tab, the tab slidably receivable within the L-shaped slot to lock the first connecting member to the second connecting member.

12. The blower assembly of claim 11, wherein the L-shaped slot includes a plurality of L-shaped slots and wherein the tab includes a plurality of tabs.

13. The blower assembly according to claim 1, wherein the second module is solely powered via the first module.

14. A blower assembly comprising:
a first module securable to a structure, the first module defining one of an air inlet and an air outlet, the first module configured to be wired to a power source, and having a first electrical connector; and
a second module defining the other of the air inlet and the air outlet, the second module including a motor, the motor drivingly engaged to a fan to, in use, drive an air flow from the air inlet to the air outlet, wherein the second module is wireless and has a second electrical connector;
wherein the second module is detachably securable to the first module by a translation such that the second module is secured to the structure via the first module, and such that the first connector and the second connector are electrically connected for the second module to be electrically powered via the first module.

15. The blower assembly of claim 14, wherein the second module has a rotational joint between a first housing and a second housing thereof, the second connector being in the first housing, the rotational joint allowing the second housing to be rotated into locking engagement with the first module while the first connector and the second connector remain electrically connected.

16. The blower assembly according to claim 15, wherein the first housing the second housing are releasably connected by snapfit connectors.

17. The blower assembly of claim 14, wherein the air outlet is defined by the first module and the air inlet defined by the second module.

18. The blower assembly according to claim 14, wherein the first module and the second module form a translation joint therebetween for engagement of the first electrical connector with the second electrical connector when the second module penetrates the first module.

19. The blower assembly of claim 14, wherein the first module defines at least one first connecting member matingly engageable to at least one second connecting member defined by the second module to maintain the first module secured to the second module.

20. The blower assembly of claim 19, wherein the at least one first connecting member includes one of an L-shaped slot and a tab and wherein the at least one second connecting member includes the other of the L-shaped slot and the tab, the tab slidably receivable within the L-shaped slot to lock the first connecting member to the second connecting member.
